(19) United States
(12) Patent Application Publication
(10) Pub. No.: US 2011/0253227 A1
(43) Pub. Date: Oct. 20, 2011

(54) SYSTEMS AND METHODS FOR CLEANING DAIRY FACILITIES

(75) Inventor: David DeWaard, Lynden, WA (US)

(73) Assignee: DARITECH, INC., Lynden, WA (US)

(21) Appl. No.: 13/089,227

(22) Filed: Apr. 18, 2011

Related U.S. Application Data
(60) Provisional application No. 61/325,486, filed on Apr. 19, 2010.

(51) Int. Cl. B08B 9/027

(52) U.S. Cl. 137/15.05; 134/166 C

(57) ABSTRACT

A cleaning system for a dairy facility comprising a rinse system including a rinse sprayer, a flush system comprising a process system for processing waste water to obtain processed water, a collection system connected between the dairy facility and the process system, and a flush sprayer. The rinse sprayer sprays rinse water in a first zone of the dairy facility, where the rinse water becomes waste rinse water after the rinse water has been sprayed in the first zone of the dairy facility. The flush sprayer sprays the processed water in a second zone of the dairy facility, where the processed water becomes waste processed water after the processed water has been sprayed in the second zone of the dairy facility. The collection system collects the waste rinse water and the waste processed water to form the waste water and directs the waste water to the process system.

### RELATED APPLICATIONS

This application (Attorney's Ref. No. P216656) claims benefit of U.S. Provisional Application Ser. No. 61/325,486 filed Apr. 19, 2010.

The subject matter of the foregoing related application is incorporated herein by reference.

### TECHNICAL FIELD

This present invention relates to systems and methods for cleaning dairy facilities and, more specifically, to systems and methods that reuse at least a portion of the water employed to clean a dairy facility.

### BACKGROUND

The present invention is of particular significance in the context of a dairy facility and that application of the present invention will be described herein in detail. The present invention may, however, have application to the cleaning of other types of facilities with cleaning considerations similar to those of a dairy facility, so the scope of the present invention should be determined with reference to the claims appended hereto and not the following detailed description of examples of the present invention.

In a modern dairy operation, cows are milked in a dairy facility comprising a milking parlor, a milk house, a holding pen, and one or more exit lanes. In the milking parlor, cows are attached to milking machinery for extracting milk from the cows. The milk is stored in the milk house. Clean conditions must be maintained in all areas of the dairy facility and especially in the milking parlor and the milk house. The need thus exists for cleaning systems and methods for maintaining proper sanitary conditions in all areas of a dairy facility.

Cleaning systems and methods for dairy facilities use fresh water and generate waste water. Fresh water is a resource that should be conserved in a typical dairy operation. Waste water contains contaminates and must be treated and/or otherwise processed before disposal. The need thus further exists for cleaning systems and methods for dairy facilities that minimize the use of fresh water and the generation of waste water.

### SUMMARY

The present invention may be embodied as a cleaning system for a dairy facility comprising a rinse system comprising a rinse sprayer and a flush system comprising a process system for processing waste water to obtain processed water, a collection system connected between the dairy facility and the process system, and a flush sprayer. The rinse sprayer sprays rinse water in a first zone of the dairy facility, where the rinse water becomes waste rinse water after the rinse water has been sprayed in the first zone of the dairy facility. The flush sprayer sprays the processed water in a second zone of the dairy facility, where the processed water becomes waste processed water after the processed water has been sprayed in the second zone of the dairy facility. The collection system collects the waste rinse water and the waste processed water to form the waste water and directs the waste water to the process system.

The present invention may also be embodied as a method of cleaning a dairy facility comprising the following steps. First and second zones of the dairy facility are defined. A process system for processing waste water to obtain processed water is provided. Rinse water is sprayed in the first zone of the dairy facility, where the rinse water becomes waste rinse water after the rinse water has been sprayed in the first zone of the dairy facility. The processed water is sprayed in the second zone of the dairy facility, where the processed water becomes waste processed water after the processed water has been sprayed in the second zone of the dairy facility. The waste rinse water and the waste processed water are collected to form the waste water. The waste water is directed to the process system.

The present invention may also be embodied as cleaning system for a dairy facility comprising a rinse system comprising a rinse sprayer and a flush system. The flush system comprises a process system, a collection system, and a flush sprayer. The process system processes waste water to obtain processed water comprising a process tank and a baffle member. An inlet portion of the process system is arranged on a first side of the baffle member. A flush outlet portion of the process system is arranged on a second side of the baffle member. A waste outlet portion is arranged below the baffle member, the inlet portion, and the flush outlet portion. The collection system is connected between the dairy facility and the inlet portion of the process system. The flush sprayer connected to the flush outlet portion of the process system. The rinse sprayer sprays rinse water in a first zone of the dairy facility, where the rinse water becomes waste rinse water after the rinse water has been sprayed in the first zone of the dairy facility. The flush sprayer sprays the processed water in a second zone of the dairy facility, where the processed water becomes waste processed water after the processed water has been sprayed in the second zone of the dairy facility. The collection system collects the waste rinse water and the waste processed water to form the waste water and directs the waste water to the process system.

### DESCRIPTION OF THE DRAWING

FIG. 1 is a highly schematic view of a first embodiment of a cleaning system and method of the present invention;

FIG. 2 is a somewhat schematic view of a second embodiment of a cleaning system and method of the present invention; and

FIG. 3 is a somewhat schematic view of a processing system of the cleaning system and method of FIG. 2.

### DETAILED DESCRIPTION

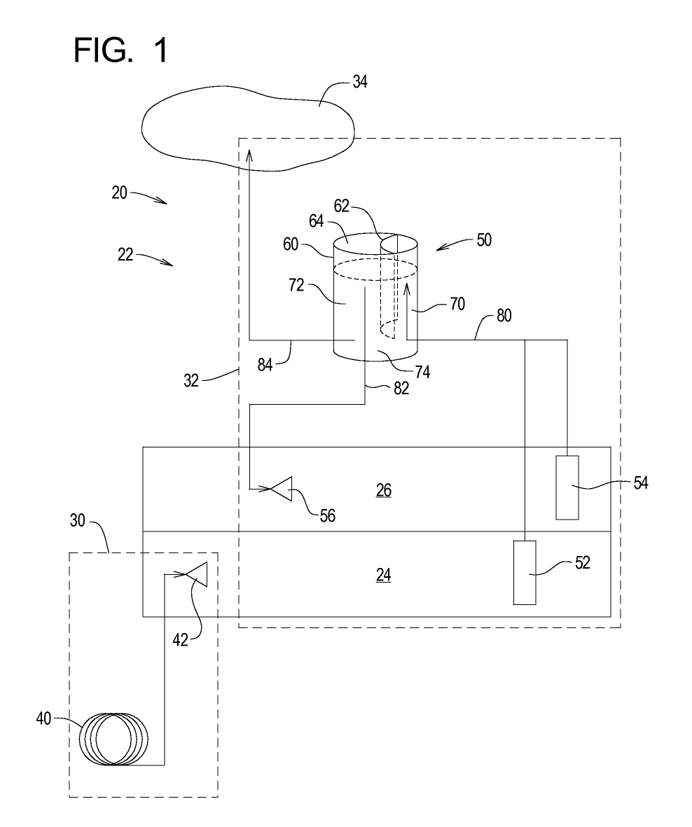

Referring initially to FIG. 1 of the drawing, depicted therein is a first example cleaning system 20 constructed in accordance with, and embodying, the principles of the present invention. The example flush system 20 is adapted to be used in a dairy facility 22 having a first zone 24 and a second zone 26. The first zone 24 corresponds to one or more areas of the dairy facility 22 requiring a first level of sanitation. The second zone 26 corresponds to one or more areas of the dairy facility requiring a second level of sanitation, where the second level of sanitation is lower than the first level of sanitation. Examples of the areas of a dairy facility 22 that may be located within or identified as part of the first zone include the milking parlor and/or milk house. Examples of areas of the dairy facility 22 that may be located within or identified as part of the second zone 26 include the holding pen and the exit lanes.

For purposes of this discussion, the term “first level of sanitation” requires the use of fresh or drinking water for cleaning, while the term “second level of sanitation” allows the use of a basic rinse liquid other than fresh or drinking water for cleaning. The term “grey water” will be used herein to refer water that does not qualify as fresh or drinking water but which is sufficiently pure for the purposes described below.

The example cleaning system 20 comprises a rinse system 30, a flush system 32, and, optionally, a lagoon 34. The rinse system 30 employs rinse water and is used to clean the first zone 24 of the dairy facility 22. The flush system 32 employs processed water and is used to clean the second zone 26 of the dairy facility 22. The flush system 32 is further configured to collect waste water resulting from the cleaning of the first and second zones 24 and 26 and to process the waste water so that at least the processed portion of the waste water is grey water that may be used for cleaning purposes. A portion of the waste water may be disposed of and/or stored in the lagoon 34. The example cleaning system 20 may be implemented as a continuous processing system.

With the foregoing general understanding of the principles of the present invention in mind, the details of the first example cleaning system 20 will now be described in further detail.

The example rinse system 30 of the first example cleaning system 20 comprises a rinse hose 40 connected to a rinse sprayer 42. The rinse hose 40 is typically connected to a source of rinse water such as a utility water supply, well, or other source of water that meets acceptable standards for cleaning the first zone 24 to the first level of sanitation. The rinse water may be potable water and may further include cleaning solutions.

The example flush system 32 comprises a process system 50, a first drain 52 located in the first zone 24, a second drain 54 located in the second zone 26, and a flush sprayer 56 also located in the second zone 26. The first drain 52 is configured to collect the rinse water after the rinse water has been used to clean the first zone 24. Liquids flowing into the first drain 52 will be referred to herein as waste rinse water. The second drain 54 is configured to collect the processed water after the processed water has been used to clean the second zone 26. Liquids flowing into the second drain 54 will be referred to herein as waste processed water. Both the waste rinse water and the waste processed water will typically be a slurry that contains both solid and liquid contaminates such as cow waste, cow feed, cow bedding material, dirt, and the like. Collectively, the waste rinse water and waste processed water will be referred to as waste water.

The waste rinse water and the waste processed water collected by the first and second drains 52 and 54 is directed into the process system 50. The process system 50 processes the waste water to obtain the processed water. As indicated above, the processed water is grey water that does not qualify as fresh or drinking water but which may be used for certain cleaning operations of a dairy facility. In particular, the process system 50 processes the waste water to remove at least a portion of the liquid and solid contaminates in the waste water so that the processed water is suitable for cleaning at least the second zone 26 of the dairy facility 22. The processed water is sprayed through the flush sprayer 56 to clean the second zone 26.

FIG. 1 further illustrates that the process system 50 comprises a tank assembly comprising a process tank 60 and a baffle member 62. The process tank 60 defines a process chamber 64, and the baffle member 62 is arranged within the process chamber 64 such that the tank assembly defines an inlet portion 70, a flush outlet portion 72, and a waste outlet portion 74 of the process chamber 64. As shown in FIG. 1, an inlet conduit 80 is connected between the first and second drains 52 and 54 and the inlet portion 70 of the process chamber 64. FIG. 1 further shows that a flush conduit 82 is connected between the flush outlet portion 72 of the process chamber 64 and the flush sprayer 56. Optionally, a waste conduit 84 is connected between the waste outlet portion 74 of the process chamber 64 and the lagoon 34.

In the example process system 50, the baffle member 62 is configured between the inlet portion 70 and the flush outlet portion 72 of the process chamber 64, and the waste outlet portion 74 is located below the baffle member 62, the inlet portion 70, and the flush outlet portion 72. Waste water thus flows into the inlet portion 70 but must flow below the baffle member and through the waste outlet portion 74 before it can flow into the flush outlet portion 72. This flow path separates or removes at least a portion of the solid contaminate material from the waste water. As a result, the waste water is processed within the process chamber 64 such that processed water is present at and flows into the inlet conduit 80. The processed water is not sufficiently sanitary for cleaning the first level of sanitation within the first zone 24, but is sufficiently sanitary for second level of sanitation within the second zone 26.

The cleaning system 20 thus employs the rinse water only where necessary and, instead of requiring that all of the waste water be disposed of, a portion of the waste water is reused as the processed water for cleaning areas that do not require rinse water. The cleaning system 20 thus minimizes use of clean rinse water and reduces the amount of waste water that must be processed or otherwise disposed of.

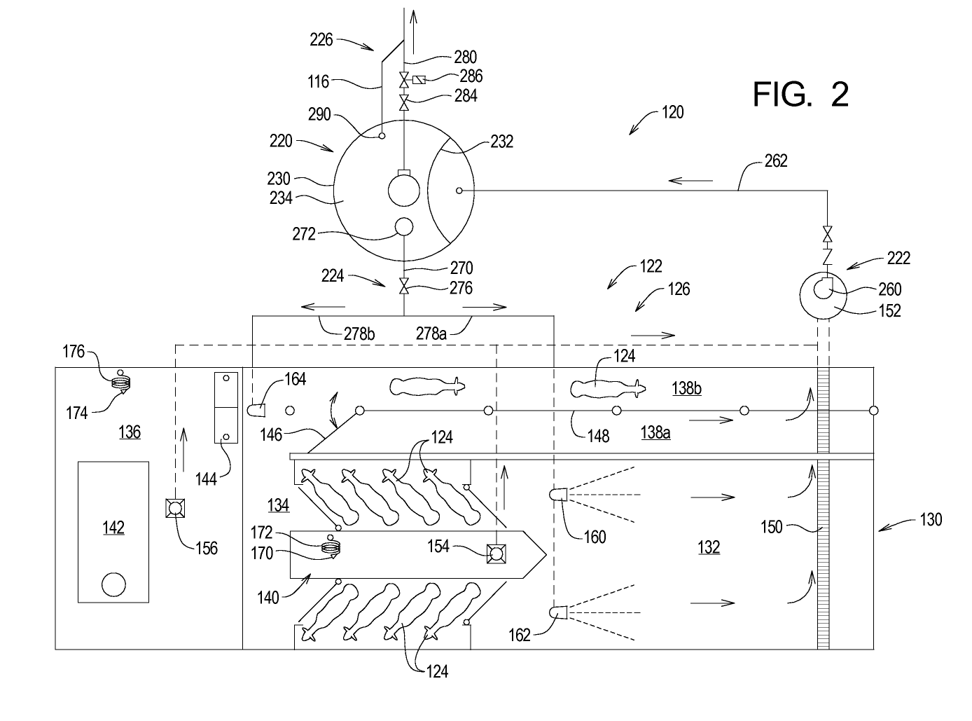

Turning now to FIG. 2 of the drawing, depicted at 120 therein is a second example cleaning system 120 constructed in accordance with, and embodying, the principles of the present invention. As shown in FIG. 2, the example cleaning system 120 is adapted to be used in a dairy operation 122 for milking cows 124.

The example dairy operation 122 employs a dairy facility 126 comprising an entrance 130, a holding pen 132, a milking parlor 134, a milk house 136, and one or more exit lanes 138a and 138b. A milking system 140 is located within the milking parlor 134, and a milk tank 142 and sinks 144 are located in the milk house 136. A swing gate 146 and a divider fence 148 are used to define the exit lanes 138a and 138b in the example dairy operation 122.

FIG. 2 further illustrates that the dairy facility 126 comprises a grated channel 150 that extends across the holding pen 132 and the exit lanes 138a and 138b and terminates in a sump pit 152. One or more floor drains 154 are arranged in the milking parlor 134, and one or more floor drains 156 are arranged in the milk house 136.

First and second holding pen sprayers 160 and 162 are located in the holding pen 132 and are spaced from the grated channel 150. One or more exit lane sprayers 164 are located in the first and second exit lanes 138a and 138b and are spaced from the grated channel 150. A milking parlor sprayer 170 is connected to a milking parlor hose 172 and located in the milking parlor 134. A milk house sprayer 174 is connected to a milk house hose 176 and located in the milk house 136.

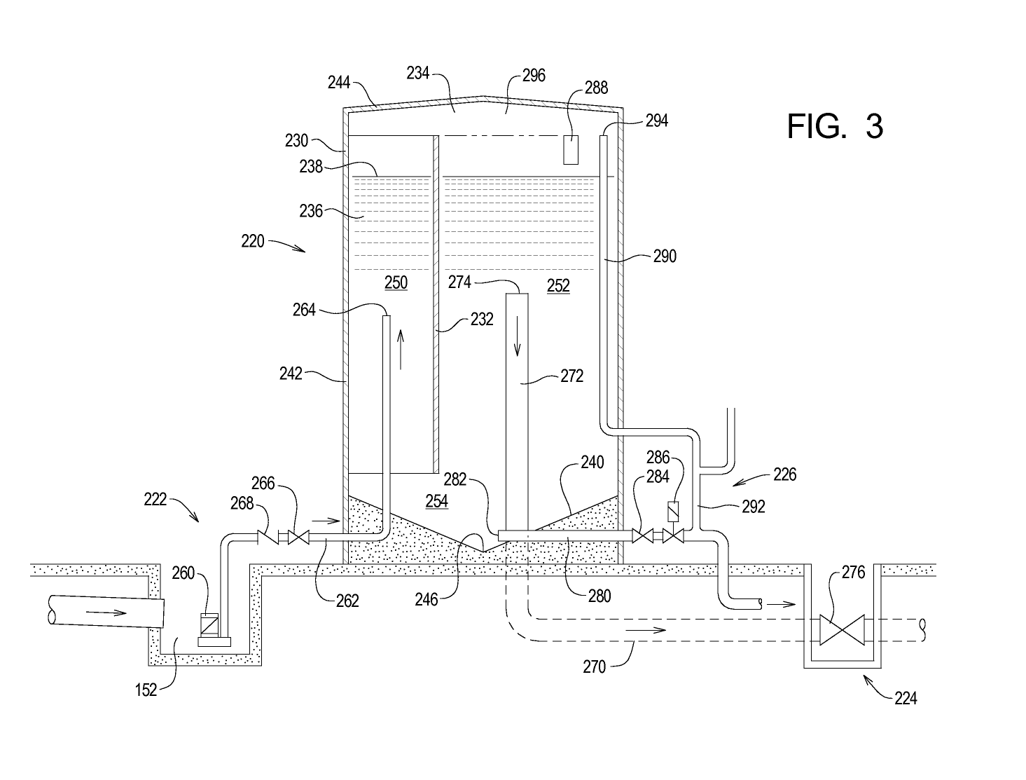

Referring now to FIGS. 2 and 3 of the drawing, a process system 220 forming a part of the cleaning system 120 will now be described. The process system 220 comprises a collection system 222, a flush system 224, and a waste system 226. The process system 220 comprises a process tank 230 and a baffle member 232. The process tank 230 defines a process chamber 234, and the baffle member 232 is located within the process chamber 234. The process chamber 234 is adapted to contain a fluid 236 defining a fluid level 238.

The process tank 230 comprises a bottom wall 240, a side wall 242, and an upper wall 244. The side wall 242 of the example process tank 230 is substantially cylindrical. The bottom wall 240 of the example tank 230 is slanted or conical and thus defines a lowest point 246 within the process chamber 234.

The baffle member 232 divides the process chamber 234 into an inlet portion 250, a flush outlet portion 252, and a waste outlet portion 254. The inlet portion 250 is arranged between the side wall 242 and a first side of the baffle member 232, while the flush outlet portion 252 is arranged between the side wall 242 and a second side of the baffle member 232. The waste outlet portion 254 is arranged below the inlet portion 250, the flush outlet portion 252, and the baffle member 232 and above the bottom wall 240. The lowest point 246 within the process chamber 234 is arranged at the bottom of the waste outlet portion 254.

The collection system 222 comprises a sump pump 260 arranged in the sump pit 152. A collection conduit 262 extends between the sump pump 260 and the inlet portion 250 of the process chamber 234. A collection conduit outlet 264 defined by the collection conduit 262 is arranged at a first level within the process chamber 234. A manual valve 266 and check valve 268 are arranged in the collection conduit 262 between the sump pump 260 and the collection conduit outlet 264 outside of the process chamber 234.

The flush system 224 comprises a primary flush conduit 270 connected to a standpipe 272 defining a standpipe inlet 274. The standpipe 272 is arranged within the process chamber 234 such that the standpipe inlet 274 is within the flush outlet portion 252 and located at a second level within the process chamber 234. A manual valve 276 is arranged in the primary flush conduit 270 outside of the process chamber 234. A first secondary flush conduit 278a is connected between the primary flush conduit 270 and the first and second holding pen sprayers 160 and 162. A second secondary flush conduit 278b is connected between the primary flush conduit 270 and the exit lane sprayer 164.

The waste system 226 comprises a waste conduit 280 that extends between the process tank 230 and a waste lagoon (not shown in FIGS. 2 and 3). In particular, the waste conduit 280 defines a waste conduit inlet 282 that is arranged within the waste outlet portion 254 of the process chamber 234. The waste conduit inlet 282 is associated with a third level within the process chamber 234. A manual valve 284 and a control valve 286 are arranged in the waste conduit 280 between the waste conduit inlet 282 and the waste lagoon outside of the process chamber 234. A control valve sensor 288 is arranged on the tank side wall 242 within the process chamber 234.

The waste system 226 further comprises an overflow conduit 290 connected to the waste conduit 280 and a vacuum break conduit 292 connected to the overflow conduit 290. The overflow conduit 290 defines an overflow inlet 294 arranged within the flush outlet portion 252 of the process chamber 232; the overflow inlet 294 is arranged at a third level within the process chamber 232. A headspace region 296 of the process chamber 232 is defined above the fluid level 238 of the fluid 236 within the process chamber 232.

As described above, the collection conduit outlet 264 is associated with a first level, the standpipe inlet 274 is associated with a second level, the waste conduit inlet 282 is associated with a third level, and the overflow inlet 294 is associated with a fourth level within the process chamber 232. The first, second, and third levels are below the fluid level 238, while the fourth level defines the uppermost point of the fluid level 238. The first and second levels are approximately equal (approximately ½ of the distance between the bottom wall 240 and the lowest point 246), with the first level being slightly lower than the second level in the example process system 220. The third level is significantly below the first and second levels and, in the example process system 220, is slightly above the lowest point 246 of the process chamber 232. The control valve sensor 288 is located immediately below the fourth level defined by the overflow inlet 294.

The operation of the second example cleaning system 120 will now be described in further detail. The cows 122 enter through entrance 130 and pass over the grated channel 150. The grated channel 150 is sloped downward toward the sump pit 152 and thus the sump pump 260. The cows 124 then enter the holding pen 132. The holding pen 132 is sloped downward towards the grated channel 150. Thus, as the holding pen 132 is scraped clean, processed water is injected upon the floor of the holding pen 132 through the sprayers 160 and 162 and directed downward toward the grated channel 150 carrying the majority of the solid and liquid effluent along with it.

Once the milking parlor 134 is clear and ready to accept cows, a first one of the cows 124 is directed into the milking parlor 134 and milked.

In the example cleaning system 120 and method of using that system 120, when it is desired to clean the milking parlor 134, once again the floor may be scraped and then flushed using the milking parlor sprayer 170. The milking parlor floor drain or drains 154 channel the effluent/water slurry to the sump pit 152.

Once one or more cows 124 have been milked, either individually, such as in a rotary parlor, or as part of a group of cows 124, the cows 124 exit the milking parlor 134 through the exit/sort lanes 138a and 138b. A swing gate 146 or similar mechanism can be utilized to sort the animals into the lanes 138a and 138b.

The exit lane sprayer 164 may be used to spray processed water in the direction in FIG. 2, thus cleaning the floor of the exit/sort lanes 138a and 138b once again towards the portion of the grated channel 150 that extend across these lanes 138a and 138b. The process water used to clean the exit/sort lanes 138a and 138b also leads to the sump pit 152.

The milk tank 142 is conventionally configured to receive the milk drawn from the cows 124 using the milking system 140 in the milking parlor 134. Once again the milk house 136 is periodically cleaned using the milk house sprayer 174 and/or the sinks 144. The example cleaning system 120 employs the milk house floor drain or drains 156 to channel waste water into the sump pit 152. As the cows 124 do not generally enter the milk house 136, the flush water being drawn therefrom is substantially cleaner and freer from effluent compared to the other regions of the dairy operation 122.

The example process tank 230 is used to recycle the waste water drawn from the sump pit 152 by the sump pump 260. In one form, the tank 230 is an above ground tank, allowing for gravity removal of the fractions therein and the reduction in the number of pumps required. The process tank 230 is also in fluid communication with the lagoon through the waste conduit 280.

Referring now more specifically to FIG. 3 of the drawing, the process tank 230 is shown in more detail. As generally described above, the process tank 230 may be operated in a continuous mode as the liquid components can be removed continuously. The solid components may also be removed continuously or periodically as described in further detail below.

The process tank 230 is coupled by the collection conduit 262 to the sump pump 260 in sump pit 152. The sump pit 152 is configured to receive effluent, gas, and water in the grated channel 150 and floor drains 154 and 156. Gas, mainly air, enters the system as the liquid/solid components flow over the floor, through the grates, through the pump, etc as a normal process of moving liquids at relatively fast speeds in any open system.

The check valve 268 prohibits fluids from flowing back through the system, either into the sump pump 260 or into the sump pit 152, which would normally be detrimental. The manual valve 266 may be used during the servicing of the process system 220, including cleaning of the process tank 230.

The effluent/water/gas combination enters the process tank 230 through the collection conduit 262 at the inlet portion 250 defined by the intake baffle member 232. From the inlet portion 250, the effluent enters the flush outlet portion 252 of the process tank 230 such that the liquid and solid components flow under the baffle member 232 and the gas (air) component flows out over the top of the baffle member 232.

Once the effluent or waste water enters the flush outlet portion 252 of the process tank 230, the heavy solid portions would remain towards the waste outlet portion 254 and the liquids would flow upwards with the flush outlet portion 252. Thus, as the solids settle out, a liquid portion, mainly comprising water with very few solids therein, can be drawn from the standpipe 272 configured to have its standpipe inlet 274 well above the level of the settled solids in the waste outlet portion 254.

This arrangement provides a very effective and inexpensive gravity separation of the liquid, gas, and solid components exiting the milking parlor 134, holding pen 132, exit lanes 138, and/or associated regions of the milking operation.

In the example process system 220, the standpipe inlet 274 of the standpipe 272 is substantially halfway between the lowest point 246 and the fourth level defined by the overflow inlet 294, which allows for withdrawal of substantially half of the volume of the process tank 230 without withdrawing any floating contaminants.

This substantially clean liquid portion of the fluid 236 within the process chamber 234 exits the process chamber 234 through the primary flush conduit 270 and ultimately through the sprayers 160, 162, and/or 164, for cleaning of the holding pen 132 and exit lanes 138 of the facility 126. As previously described, this “gray water” is not appropriate for use in the milking parlor 134 and/or in the milk house 136 for sanitary reasons.

The horizontal diameter of the tank 230 and the relative size of the baffle member 232 relative to the overall size of the tank 230 is predetermined such that the settling rate of the solids in comparison to the desired flow rate of the overall apparatus yield sufficient flow for operation of the sprayers 160, 162, and/or 164 as described above.

The manual valve 276 allows the process tank 230 to be serviced. The solid portions should be removed from the process tank 230 continuously or periodically. The manual valve 284 allows the waste conduit 280 to be closed for servicing of the process system 220.

Additionally, the control valve 286 may be provided for automatic removal of waste based on predetermined parameters. For example, the control valve sensor 288 may be configured to actuate the control valve 286 when the process tank 230 is full, thus allowing effluent to exit through the waste conduit 280 to a manure handling system such as a treatment lagoon (not shown). In one form, the control valve sensor 288 comprises a level probe or float valve. The control valve 286 may take the form of an air-actuated valve such as a knife valve. This use of a control valve 286 and control valve sensor 288 allows for the mainly solid fraction to be removed constantly as the process tank 230 fills.

As generally described above, the overflow conduit 290 may be provided, with the overflow inlet substantially at or just below the upper wall 244 of the process tank 230, indicating the upper limit of the volume capability of the process tank 230. The overflow conduit 290 therefore functions as a standard overflow and vacuum break whereupon the effluent and water within the process tank 230, upon reaching the overflow inlet 294, flows through the overflow conduit 290 into the waste conduit 280 and, as previously described, out toward the manure handling system.

The vacuum break conduit 292 is provided to maintain neutral pressure between the headspace 296 and atmosphere. The use of a vacuum break such as the vacuum break conduit 292 is helpful to maintain proper operation of the process system 220 as the volume of fluid/solid changes due to influx of fluid from the collection conduit 262 and/or withdrawal of material from the tank 230. The vacuum break conduit 292 or another vent may be utilized to allow the gas (air) fraction filling the headspace 296 to be withdrawn without requiring the gas fraction to be vented through the waste conduit 280.

While the present invention is illustrated by description of several embodiments and while the illustrative embodiments are described in detail, it is not the intention of the applicants to restrict or in any way limit the scope of the appended claims to such detail. Additional advantages and modifications within the scope of the appended claims will readily appear to those sufficed in the art. The invention in its broader aspects is therefore not limited to the specific details, representative apparatus and methods, and illustrative examples shown and described. Accordingly, departures may be made from such details without departing from the spirit or scope of applicants' general concept.

What is claimed is:

1. A cleaning system for a dairy facility comprising:
a rinse system comprising a rinse sprayer;
a flush system comprising
a process system for processing waste water to obtain processed water,
a collection system connected between the dairy facility and the process system, and
a flush sprayer; whereby
the rinse sprayer sprays rinse water in a first zone of the dairy facility, where the rinse water becomes waste rinse water after the rinse water has been sprayed in the first zone of the dairy facility;
the flush sprayer sprays the processed water in a second zone of the dairy facility, where the processed water becomes waste processed water after the processed water has been sprayed in the second zone of the dairy facility;
the collection system collects the waste rinse water and the waste processed water to form the waste water and directs the waste water to the process system.

2. A cleaning system as recited in claim 1, in which:
the process system comprises a tank assembly defining an inlet portion and a flush outlet portion;
the collection system comprises an inlet conduit arranged to direct the waste water to inlet portion of the process system; and
the flush system comprises a flush conduit connected between the flush outlet portion of the process system and the flush sprayer.

3. A cleaning system as recited in claim 2, in which the tank assembly comprises:
a process tank; and
a baffle member; whereby
the inlet portion of the process system is arranged on a first side of the baffle member; and
the flush outlet portion of the process system is arranged on a second side of the baffle member.

4. A cleaning system as recited in claim 2, in which the tank assembly is configured to cause the waste material to flow downward from the inlet portion and then upward into the flush outlet portion.

5. A cleaning system as recited in claim 2, in which the tank assembly further defines a waste outlet portion, where the tank assembly is configured to cause the waste material to flow from the inlet portion and through the waste outlet portion and into the flush outlet portion.

6. A cleaning system as recited in claim 5, in which the tank assembly comprises:
a process tank; and
a baffle member; whereby
the inlet portion of the process system is arranged on a first side of the baffle member;
the flush outlet portion of the process system is arranged on a second side of the baffle member; and
the waste outlet portion is arranged below the baffle member, the inlet portion, and the flush outlet portion.

7. A cleaning system as recited in claim 5, in which the process system further comprises a waste conduit arranged to remove material from the waste outlet portion of the process system.

8. A cleaning system as recited in claim 7, in which the waste conduit directs material from the waste outlet portion of the process system to a waste lagoon.

9. A cleaning system as recited in claim 1, in which the collection system comprises:
at least one first drain arranged in the first zone; and
at least one second drain arranged in the second zone.

10. A cleaning system as recited in claim 1, in which the collection system comprises:
a sump pit for collecting the waste material; and
a sump pump for pumping the waste material from the sump pit to the process system.

11. A method of cleaning a dairy facility comprising the steps of:
defining first and second zones of the dairy facility;
providing a process system for processing waste water to obtain processed water;
spraying rinse water in the first zone of the dairy facility, where the rinse water becomes waste rinse water after the rinse water has been sprayed in the first zone of the dairy facility;
spraying the processed water in the second zone of the dairy facility, where the processed water becomes waste processed water after the processed water has been sprayed in the second zone of the dairy facility;
collecting the waste rinse water and the waste processed water to form the waste water; and
directing the waste water to the process system.

12. A method as recited in claim 11, further comprising the steps of:
the step of providing a process system comprises the step of providing a tank assembly defining an inlet portion and a flush outlet portion;
the step of directing the waste water to the process system comprises the step of directing the waste water to inlet portion of the process system; and
the step of spraying the processed water comprise the step of removing processed water from the flush outlet portion of the process system.

13. A method as recited in claim 12, in which the step of providing the tank assembly comprises the step of arranging a baffle member within a process tank such that:
the inlet portion of the process system is arranged on a first side of the baffle member; and
the flush outlet portion of the process system is arranged on a second side of the baffle member.

14. A method as recited in claim 12, further comprising the step of causing the waste material to flow downward from the inlet portion and then upward into the flush outlet portion.

15. A method as recited in claim 12, in which:
the step of providing the tank assembly further comprises the step of defining a waste outlet portion; and
the step of causing the waste material to flow downward from the inlet portion and upward into the flush outlet portion comprises the step of causing the waste material to flow through the waste outlet portion.

16. A cleaning system for a dairy facility comprising:
a rinse system comprising a rinse sprayer;
a flush system comprising
a process system for processing waste water to obtain processed water comprising a process tank and a baffle member, where
an inlet portion of the process system is arranged on a first side of the baffle member,
a flush outlet portion of the process system is arranged on a second side of the baffle member; and
a waste outlet portion is arranged below the baffle member, the inlet portion, and the flush outlet portion,
a collection system connected between the dairy facility and the inlet portion of the process system, and
a flush sprayer connected to the flush outlet portion of the process system; whereby
the rinse sprayer sprays rinse water in a first zone of the dairy facility, where the rinse water becomes waste rinse water after the rinse water has been sprayed in the first zone of the dairy facility;
the flush sprayer sprays the processed water in a second zone of the dairy facility, where the processed water becomes waste processed water after the processed water has been sprayed in the second zone of the dairy facility;
the collection system collects the waste rinse water and the waste processed water to form the waste water and directs the waste water to the process system.

17. A cleaning system as recited in claim 16, in which the tank assembly further defines a waste outlet portion, where the tank assembly is configured to cause the waste material to flow downward from the inlet portion, through the waste outlet portion, and upward into the flush outlet portion.

18. A cleaning system as recited in claim 16, in which the process system further comprises a waste conduit arranged to remove material from the waste outlet portion of the process system.

19. A cleaning system as recited in claim 16, in which the collection system comprises:
at least one first drain arranged in the first zone; and
at least one second drain arranged in the second zone.

20. A cleaning system as recited in claim 16, in which the collection system comprises:
a sump pit for collecting the waste material; and
a sump pump for pumping the waste material from the sump pit to the process system.
